(19) United States
(12) Patent Application Publication
(10) Pub. No.: US 2026/0308353 A1
(43) Pub. Date: Oct. 8, 2026

(54) REDUCTION IN BENZOTHIAZOLE EMISSIONS WHEN HEATING BENZOTHIAZOLE-CONTAINING RUBBER

(71) Applicant: LANXESS Deutschland GmbH, Cologne (DE)

(72) Inventors: Ralf-Johann Moritz, Neuss (DE); Thomas Klein, Heidelberg (DE)

(73) Assignee: LANXESS Deutschland GmbH, Cologne (DE)

(21) Appl. No.: 19/482,344

(22) PCT Filed: May 8, 2024
(86) PCT No.: PCT/EP2024/062673

§ 371 Date: Nov. 7, 2025

(30) Foreign Application Priority Data
May 15, 2023 (EP) 23173383.3

(51) Int. Cl. C08K 3/32

(52) U.S. Cl. CPC C08K 3/32; C08K 2003/329

(57) ABSTRACT

Reducing benzothiazole emission during heating of rubber containing benzothiazole The invention relates to a process for reducing benzothiazole emission during heating of rubber containing benzothiazole and/or substances evolving benzothiazole during heating, wherein the heating is carried out in the presence of polyphosphoric acid (PPA).

End-of-life tyre rubber has been recycled as a modifier for binding agents (bitumen) on asphalt-based road surfaces for decades. While the use of natural rubber as a modifier of bitumen dates back to the 19th century, ground rubber granulate from end-of-life tyres was first used in this context in 1960.

Rubber, whether of natural or synthetic origin or as recycled waste material from end-of-life tyres, is used as a polymeric modifier for bitumen. Polymers extend the temperature range over which bitumen exhibits sufficiently good properties (inter alia avoidance of permanent deformation and cracking) as a binder in road surfacing. End-of-life tyre rubber has proven to be a sustainable alternative to synthetic polymers since the material is generated as waste, and storage in landfills or thermal recovery with corresponding release of CO₂ are avoided.

However, end-of-life tyre rubber has a number of disadvantages which could prevent broad application. Since it is a vulcanized material its crosslinking via sulfur bridges means it is difficult to mix with bitumen. This may be alleviated using additives as described for example in WO2017032661 and WO2021028290.

Rubber, especially rubber from end-of-life tyres may contain benzothiazole if this additive was added during production. Furthermore, substances which can evolve benzothiazole during heating may have been added to the rubber during its production, for example 2-mercaptobenzothiazole or amides of benzothiazole or 2-mercaptobenzothiazole. In the context of the invention substances which can evolve benzothiazole during heating are preferably to be understood as meaning compounds which evolve benzothiazole at 160° C., particularly preferably at a temperature of 120° C. to 160° C. and most preferably at a temperature of 100° C. to 120° C. The use of benzothiazole or substances evolving benzothiazole during heating as additives for rubber varies greatly by region and occurs much more often in Europe than in Asia or the USA for example. These additives are mostly employed in the production of passenger car tyres but may also be used in truck tyres.

The release of benzothiazole during heating of rubber to temperatures of about 100° C. is problematic. For example, concerns about roadbuilding emissions have recently come to the fore, as described in Patrik T Nilsson et al., Annals of Work Exposures and Health, Vol 62, Issue 7, August 2018, Pages 828-839. Although rubber as a modifier does not significantly increase and in some cases even reduces the emission of volatile, hydrocarbon-based components of bitumen, the presence of benzothiazole has an adverse effect on the environment from both an olfactory and toxicological standpoint, especially when using end-of-life rubber.

A further additive already used for modifying bitumen is polyphosphoric acid (PPA). The latter has been used infrequently as a modifier for the flow behaviour and solidification point of bitumen or asphalt to reduce cracking in winter or to inhibit rutting in hot summers. A use is disclosed in conjunction with rubber flour or comminuted tyres, for example in G. Yadollahi et al., Construction and Building Materials 25 (2011) 3108-3116, but not in conjunction with rubber containing benzothiazole and/or substances evolving benzothiazole during heating. There was therefore a need for a process for reducing benzothiazole emission during heating of rubber containing benzothiazole and/or substances evolving benzothiazole during heating especially in a process for producing asphalt by heating of asphalt binder (bitumen) and rubber containing benzothiazole and/or substances evolving benzothiazole during heating.

It has now been found that, surprisingly, a reduction in benzothiazole emission during heating of rubber containing benzothiazole and/or substances evolving benzothiazole during heating may be achieved by carrying out the heating in the presence of polyphosphoric acid (PPA).

The present invention thus relates to a process for reducing benzothiazole emission during heating of rubber containing benzothiazole and/or substances evolving benzothiazole during heating, wherein the heating is carried out in the presence of polyphosphoric acid (PPA).

The process for reducing benzothiazole emission is preferably carried out during heating of rubber containing benzothiazole.

The heating is typically carried out to a temperature of at least 100° C., preferably of between 100° C. and 190° C. and particularly preferably of between 120° C. and 160° C.

The rubber employed is preferably in the form of comminuted end-of-life tyres, particularly preferably rubber flour from end-of-life tyres. The rubber flour may be hot-milled or else cryogenically milled rubber flour as available for example from MRH Mülsener Rohstoff und Handelsgesellschaft mbH.

In a preferred embodiment the phosphoric acid and the rubber containing benzothiazole and/or substances evolving benzothiazole during heating are mixed before heating.

It is preferable when the polyphosphoric acid is homogeneously applied to the surface of the rubber. Any type of mixer suitable for production of a homogeneous solid mixture may be used to apply the PPA to the surface of the rubber. This may be for example an Ultra Turrax stirrer or a ploughshare mixer, irrespective of whether it has a horizontal or vertical construction. It is alternatively also possible to employ a spraying process in which heated, liquid polyphosphoric acid is atomized by a nozzle to a mist which is then deposited on the surface of the rubber.

The phosphoric acid employed is selected from polyphosphoric acids of the type PPA 95% to PPA 124%, preferably of the type PPA 100% to PPA 118% and particularly preferably of the type PPA 105% to 115%. The figures refer to the concentration of the polyphosphoric acid. Concentrations greater than 100% are possible because the proportion of P₂O₅ in H₃PO₄ is included.

Polyphosphoric acids (PPAs) are formed for example through partial hydrolysis of phosphorus pentoxide with substoichiometric amounts of water. In addition to partially hydrolysed cyclic compounds, the polyphosphoric acids consist substantially of linear molecules of general formula H₍ₙ₊₂₎O₍₃ₙ₊₁₎Pₙ as described for example in Brief Review of the Chemistry of Polyphosphoric Acid (PPA) and Bitumen, J.-F. Masson Energy & Fuels, v. 22, no. 4, June 2008, pp. 2637-2640.

The polyphosphoric acid is typically used in an amount of 0.5% to 20% by weight, preferably of 3% to 10% by weight and particularly preferably of 5% to 7% by weight based on the rubber.

The process is ideally used to reduce benzothiazole emissions in the production of asphalt from rubber and bitumen.

The present invention thus relates to a process for producing producing asphalt with reduced benzothiazole emission comprising the mixing and heating of:
a) rubber containing benzothiazole and/or substances evolving benzothiazole during heating
b) bitumen
c) polyphosphoric acid (PPA).

It is preferable when the process is used in the production of asphalt using rubber containing benzothiazole.

The rubber employed is preferably in the form of comminuted end-of-life tyres, particularly preferably rubber flour from end-of-life tyres. The rubber flour may be hot-milled or else cryogenically milled.

The heating is typically carried out to a temperature of at least 100° C., preferably of between 100° C. and 190° C. and particularly preferably of between 120° C. and 160° C.

In a preferred embodiment the phosphoric acid and the rubber containing benzothiazole and/or substances evolving benzothiazole during heating are mixed before heating and subsequently blended with the bitumen that has already been heated to a temperature of at least 100° C., preferably of between 100° C. and 190° C. and particularly preferably of between 120° C. and 160° C.

It is preferable when the polyphosphoric acid is homogeneously applied to the surface of the rubber.

The phosphoric acid employed is selected from polyphosphoric acids of the type PPA 95% to PPA 124%, preferably of the type PPA 100% to PPA 118% and particularly preferably of the type PPA 105% to 115%.

The polyphosphoric acid is typically used in an amount of 0.5% to 20% by weight, preferably of 3% to 10% by weight and particularly preferably of 6% to 8% by weight based on the rubber.

The present invention further relates to the use of polyphosphoric acid for reducing benzothiazole emission during heating of rubber containing benzothiazole and/or substances evolving benzothiazole during heating and to the use of polyphosphoric acid for reducing benzothiazole emission in the production of asphalt from rubber containing benzothiazole and/or substances evolving benzothiazole during heating and bitumen by heating these substances, especially in the embodiments recited above.

The present invention further relates to asphalt containing:
a) rubber containing benzothiazole and/or substances evolving benzothiazole during heating
b) bitumen
c) polyphosphoric acid (PPA).

The present invention further relates to asphalt obtainable using the process according to the invention for reducing benzothiazole emission during heating of rubber or by the process according to the invention for producing asphalt.

### EXAMPLE

The reduction in emissions and odour-forming components was detected using the so-called “purge and trap” GC-MS technique[6] which allows for assigning the individual molecules via their mass spectrum and content determination of the volatile components in the ambient air via the peak areas in the GC spectrogram.

In one example cryogenically milled rubber flour from truck tyres of European origin having a particle size of 0.2-0.4 mm was admixed with different amounts of polyphosphoric acid PPA 118%, PPA 115%, PPA 108% und PPA 105% and intimately mixed using an Ultra Turrax stirrer (T 25 Basic homogenizer). Rubber flour from passenger car tyres may be treated analogously.

In a further example the cold-milled rubber flour mm was admixed with different amounts of polyphosphoric acid PPA 118%, PPA 115%, PPA 108% and PPA 105% and intimately mixed using a conventional blade stirrer for laboratory use, In both cases 0% to 10% by weight of PPA were employed based on rubber flour and intimately mixed for about 30-45 minutes. Subsequently all samples were heated to 120° C. or 160° C. and the volatile constituents completely expelled from the cold-milled rubber flour and condensed and collected in a cold trap. The trap was then heated and the analytes were sent to the GCMS spectrometer in bundled form.

All samples where at least 0.5% by weight of PPA based on rubber flour was employed showed a reduction in the amount of benzothiazole released. Upon addition of at least 6% by weight of PPA to the rubber flour the emission of benzothiazole both at 120° C. and at 160° C. was able to be completely inhibited in all cases.

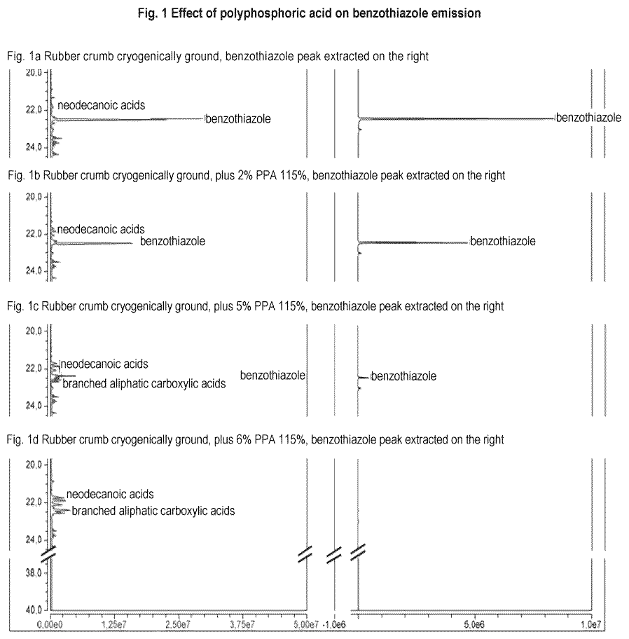

FIG. 1 shows the inhibiting effect of PPA on benzothiazole using the example of cryogenically milled rubber flour without PPA, cryogenically milled rubber flour with 2% PPA 115%, cryogenically milled rubber flour with 5% PPA 115% and cryogenically milled rubber flour with 6% PPA 115% at 120° C. The data were obtained by P&T GCMS and show detail sections at the typical retention time of benzothiazole of about 22.45 min. The extracted benzothiazole peak is shown on the right-hand side.

1. A process for reducing benzothiazole emission during heating of rubber containing benzothiazole and/or substances evolving benzothiazole during heating, comprising the step of heating the rubber in the presence of polyphosphoric acid (PPA).

2. The process according to claim 1, wherein the heating is carried out to a temperature of at least 100° C.

3. The process according to claim 1, wherein the polyphosphoric acid and the rubber containing benzothiazole and/or substances evolving benzothiazole during heating are mixed before the step of heating.

4. The process according to claim 1, wherein the polyphosphoric acid employed is selected from polyphosphoric acids of the type PPA 95% to PPA 124%.

5. The process according to claim 1, wherein the polyphosphoric acid is used in an amount of 0.5% to 20% by weight, based on the rubber.

6. The process according to claim 1, wherein the rubber employed is in the form of comminuted end-of-life tires.

7. A process for producing asphalt with reduced benzothiazole emissions comprising the mixing and heating of:
a) rubber containing benzothiazole and/or substances evolving benzothiazole during heating;
b) bitumen; and
c) polyphosphoric acid (PPA).

8. The process according to claim 7, wherein the heating is carried out to a temperature of at least 100° C.

9. The process according to claim 7, wherein the polyphosphoric acid and the rubber containing benzothiazole and/or substances evolving benzothiazole during heating are mixed before the heating.

10. The process according to claim 7, wherein the polyphosphoric acid employed is selected from polyphosphoric acids of the type PPA 95% to PPA 124%.

11. The process according to claim 7, wherein the polyphosphoric acid is used in an amount of 0.5% to 20% by weight, based on the rubber.

12. The process according to claim 7, wherein the rubber employed is in the form of comminuted end-of-life tires.

13.-15. (canceled)

16. Asphalt containing:
a) rubber containing benzothiazole and/or substances evolving benzothiazole during heating;
b) bitumen; and
c) polyphosphoric acid (PPA).
